(19) United States
(12) Patent Application Publication
(10) Pub. No.: US 2017/0313484 A1
(43) Pub. Date: Nov. 2, 2017

(54) LASHING BELT

(71) Applicant: Tong NA, Beijing (CN)

(72) Inventor: Tong NA, Beijing (CN)

(21) Appl. No.: 15/188,030

(22) Filed: Jun. 21, 2016

(30) Foreign Application Priority Data
Apr. 29, 2016 (CN) 201610282547.4
Apr. 29, 2016 (CN) 201620386851.9

(51) Int. Cl. B65D 63/10; F16B 2/08

(52) U.S. Cl. CPC B65D 63/1027; F16B 2/08; B65D 2563/108

(57) ABSTRACT

A lashing belt comprises a belt body having a fixed end and a free end and a fixed part connected with the fixed end of the belt body. The fixed part comprises a first head portion including a first snap hole and a first snap disposed in the first snap hole and a second head portion including a second snap hole and a second snap disposed in the second snap hole. The belt body comprises a plurality of skew teeth on a surface of the belt body, the first and second snaps respectively comprise a plurality of ratchets, and the axes of the first and second snap holes are parallel with each other.

### CROSS-REFERENCE TO RELATED APPLICATIONS

The present application claims priority under 35 U.S.C. §119 to Chinese Patent Applications No. 201610282547.4 and No. 201620386851.9, filed on Apr. 29, 2016, in the State Intellectual Property Office of China, which are incorporated by reference herein in their entirety.

### TECHNICAL FIELD

Embodiments of the present invention relate to a lashing belt, particularly to a lashing belt which is capable of implementing lashing in multiple directions and/or in multiple turns.

### BACKGROUND

Lashing belts are used to lash objects fast. Due to the advantages of sturdy self-locking and convenience, lashing belts are widely used in the industries of electronics, telecommunications, construction, automobiles as well as everyday life, and have become essential consumables. The head portion of a lashing belt comprises a snap hole and a snap disposed in the snap hole. A plurality of skew teeth are disposed on a surface of a belt body with even intervals. After the belt body is inserted into the snap hole, the skew teeth of the belt body can be engaged with a ratchet of the snap so as to implement sturdy locking. However, since only one head portion is disposed, lashing can be implemented in only one direction and one turn.

In practice, many objects require being lashed in multiple directions and/or multiple turns. For example, a rectangular packing box needs cross lashing in both of a vertical direction and a horizontal direction. As another example, a plurality of network cables need being lashed in two turns. In these cases, two conventional lashing belts are required. However, the two lashing belts should be lashed separately since they are spaced apart from each other, resulting in relatively poor effect. In addition, in case of a small object, there will be a relatively long remaining portion when a conventional lashing belt is used, resulting in a waste of sources.

### SUMMARY

In view of this, embodiments of the present invention provide a lashing belt which can be used to lash an object in multiple directions and/or multiple turns so as to realize an excellent tightening effect.

According to embodiments of the present invention, a lashing belt is provided. The lashing belt comprises a belt body having a fixed end and a free end and a fixed part connected with the fixed end of the belt body. The fixed part comprises a first head portion including a first snap hole and a first snap disposed in the first snap hole and a second head portion including a second snap hole and a second snap disposed in the second snap hole. The belt body comprises a plurality of skew teeth on a surface of the belt body, the first and second snaps respectively comprise a plurality of ratchets, and the axes of the first and second snap holes are parallel with each other.

An angle between the ratchets of the first and second snaps may be 90°. The first head portion and the second head portion may be arranged in a length direction of the belt body. Alternatively, the first head portion and the second head portion may be arranged in a direction perpendicular to a length direction of the belt body.

Cross-sections of the first and second snap holes may have a convex shape. A convex section of the first snap hole may be protruded toward the belt body, and a convex section of the second snap hole may be protruded toward the first snap hole.

An angle between the ratchets of the first and second snaps may be 0°. The first head portion and the second head portion may be arranged in a length direction of the belt body. Cross-sections of the first and second snap holes may have a convex shape. A convex section of the first snap hole may be protruded toward the belt body, and a convex section of the second snap hole may be protruded toward the first snap hole.

An angle between the ratchets of the first and second snaps may be 180°. The first head portion and the second head portion may be arranged in a direction perpendicular to a length direction of the belt body. Cross-sections of the first and second snap holes may have a convex shape. A convex section of the first snap hole may be protruded toward the belt body and a convex section of the second snap hole may be protruded toward the first snap hole.

Cross-sections of the first and second snap holes may have a rectangular shape or an elliptical shape.

The free end of the belt body may have a tapered width.

The lashing belt may further comprise a first elastic pressing section disposed at an end of the first snap and extended outside the first snap hole and a second elastic pressing section disposed at an end of the second snap and extended outside the second snap hole.

With the lashing belt according to embodiments of the present invention, lashing in both of horizontal and vertical directions and/or lashing in double turns in a same direction can be implemented. Thus tightening effect is increased and resources are saved.

### BRIEF DESCRIPTION OF DRAWINGS

These and/or other aspects will become apparent and more readily appreciated from the following description of the embodiments, taken in conjunction with the accompanying drawings in which:

FIG. 1 is a schematic view illustrating a structure of a lashing belt according to an embodiment of the present invention;

FIG. 2 is a schematic cross-sectional view illustrating the lashing belt shown in FIG. 1;

FIG. 3 is a schematic view illustrating a lashing process using the lashing belt shown in FIG. 1;

FIG. 4 is a schematic view illustrating a structure of a lashing belt according to another embodiment of the present invention;

FIG. 5 is a schematic cross-sectional view illustrating the lashing belt shown in FIG. 4; and

FIG. 6 is a schematic view illustrating a structure of a lashing belt according to still another embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Hereinafter embodiments of the present invention will be described in detail with reference to the accompanying drawings.

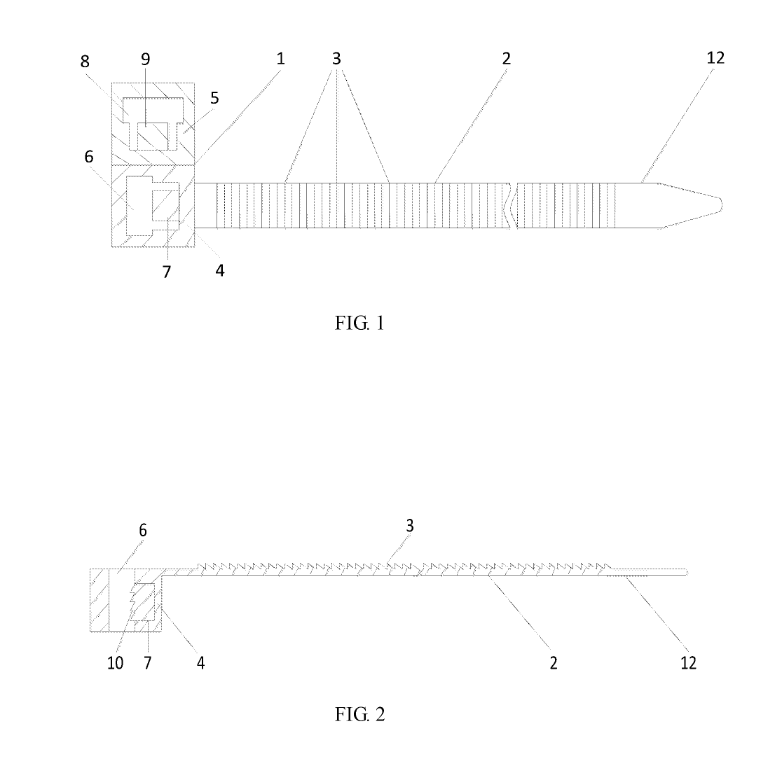

FIG. 1 is a schematic view illustrating a structure of a lashing belt according to an embodiment of the present invention; FIG. 2 is a schematic cross-sectional view illustrating the lashing belt shown in FIG. 1.

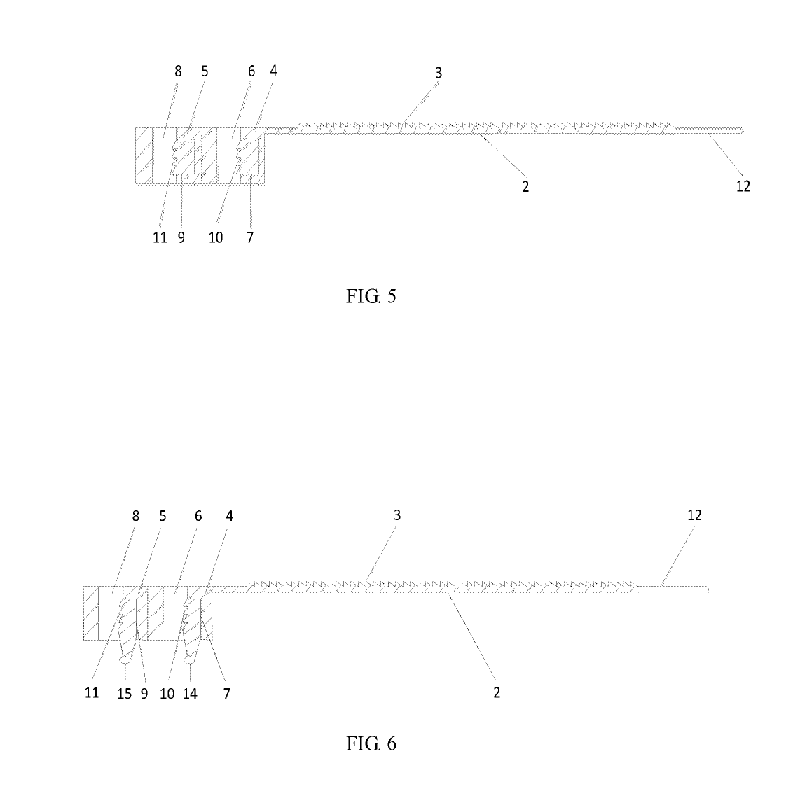

As shown in FIGS. 1 and 2, a lashing belt according to an embodiment of the present invention includes a belt body 2 and a fixed part 1 fixed to a fixed end of the belt body 2. The belt body 2 comprises a plurality of skew teeth 3 on a surface thereof. The plurality of skew teeth 3 are arranged in a length direction of the belt body 2, i.e., a left-right direction shown in FIG. 1, with even intervals. The fixed part 1 includes a first head portion 4 and a second head portion 5. The first head portion 4 includes a first snap hole 6 and a first snap 7 disposed inside the first snap hole 6. Similarly, the second head portion 5 includes a second snap hole 8 and a second snap 9 disposed inside the second snap hole 8. A plurality of ratchets 10 and a plurality of ratchets 11 which can be engaged with the skew teeth 3 are disposed on the first snap 7 and the second snap 9 respectively. Since the ratchets 10 and 11 are positioned inside the first and second snaps 7 and 9 respectively, the ratchets 10 are not shown in FIG. 1, but can be seen in FIGS. 2, 5 and 6, and the ratchets 11 are not shown in FIGS. 1 and 2, but can be seen in FIGS. 5 and 6.

An axis of the first snap hole 6 and an axis of the second snap hole 8 extend along an up-down direction shown in FIG. 2 and are parallel with each other. An angle is formed between the ratchets 10 and the ratchets 11, and the angle may be 0°, 90° or 180°. The first and second head portions 4 and 5 are connected to each other. A direction, along which they are arranged, i.e., an up-down direction shown in FIG. 1, is perpendicular to the length direction of the belt body 2.

In this embodiment, the cross-sections of the first and second snap holes 6 and 8 have a convex shape. The first and second snaps 7 and 9 are positioned in convex sections of the first and second snap holes 6 and 8 respectively. As shown in FIG. 1, a direction along which the convex section of the first snap hole 6 is protruded is the same as the length direction of the belt body 2, while a direction along which the convex section of the second snap hole 8 is protruded is perpendicular to the length direction of the belt body 2. In other words, the convex section of the first snap hole 6 is protruded toward the belt body 2 while the convex section of the second snap hole 8 is protruded toward the first snap hole 6.

As shown in FIG. 1, both of the convex sections of the first and second snap holes 6 and 8 are extended toward the belt body 2. That is, as shown in FIG. 1, the convex section of the first snap hole 6 is extended rightward and the convex section of the second snap hole 8 is extended downward. In this embodiment, an angle between the ratchets 10 and 11 is 90°, thus cross lashing can be implemented, which will be described in detail later.

In addition, it will be understood that the direction along which the first and second head portions 4 and 5 are arranged is just an example. In other embodiments, the first and second head portions 4 and 5 can be arranged along the length direction of the belt body 2. In this case, cross lashing can also be implemented provided that the angle between the ratchets 10 and 11 is 90°.

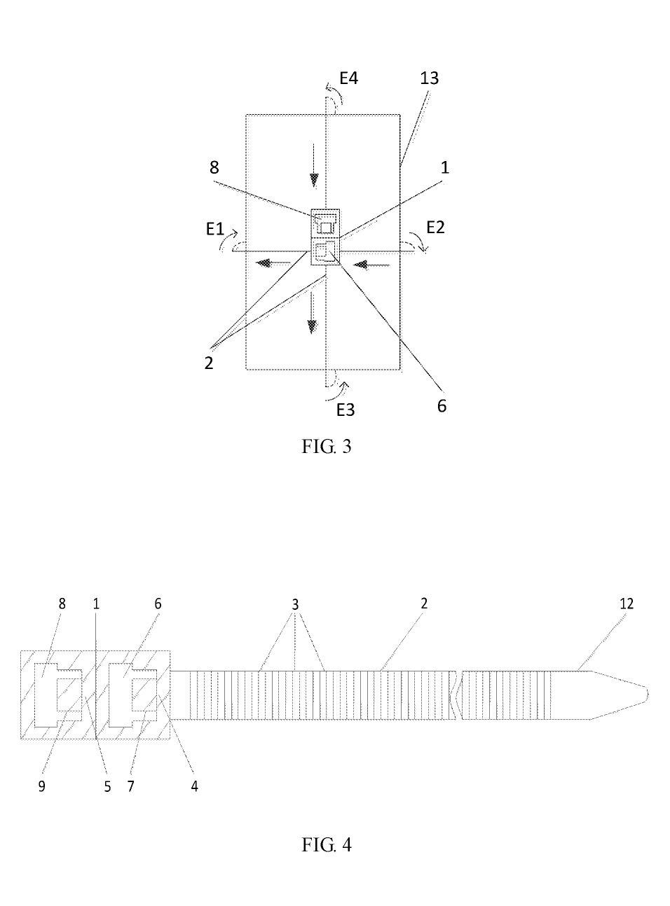

Hereinafter, a lashing process using the lashing belt shown in FIGS. 1-2 will be described in detail further with reference to FIG. 3.

FIG. 3 is a schematic view illustrating a lashing process using the lashing belt shown in FIGS. 1 and 2. As shown in FIG. 3, after surrounding an object 13 to be lashed one turn along the directions E1 and E2, the belt body 2 passes through the first snap hole 6. In this way, the first snap 7 in the first snap hole 6, the ratchets 10 of the first snap 7, the belt body 2 and the skew teeth 3 of the belt body 2 collectively form a first locking structure, thereby implementing lashing in the horizontal direction.

After that, the belt body 2 surrounds the object 13 one turn along the directions E3 and E4 which are perpendicular to the directions E1 and E2, and then passes through the second snap hole 8. Similarly, the second snap 9 in the second snap hole 8, the ratchets 11 of the second snap 9, the belt body 2 and the skew teeth 3 of the belt body 2 collectively form a second locking structure, thereby implementing lashing in the vertical direction.

Those skilled in the art would understand that the above-describe lashing sequence is just an example. Alternatively, the lashing in the vertical direction can be implemented firstly and the lashing in the horizontal direction can be implemented thereafter.

Since there are two holes in the lashing belt, i.e., two snap holes 6 and 8 are provided, meanwhile the angle between ratchets 10 and 11 located in the two snap holes 6 and 8 respectively is 90°, cross lashing in both of the horizontal and vertical directions can be implemented. Compared with the prior art in which two separate lashing belts are required to do so, the lashing belt according to embodiments of the present invention is more convenient and economic. In addition, since the lashing in two different directions is implemented by one lashing belt and the two locking structures are connected to each other, the lashing is tighter compared with the prior art.

Hereinafter, another embodiment of the present invention will be described with reference to FIGS. 4 and 5. The like or similar parts as the embodiment shown in FIGS. 1 and 2 will be assigned like reference numbers and repeated description thereof may be omitted.

FIG. 4 is a schematic view illustrating a structure of a lashing belt according to another embodiment of the present invention; FIG. 5 is a schematic cross-sectional view illustrating the lashing belt shown in FIG. 4.

As shown in FIGS. 4 and 5, the first head portion 4 and the second head portion 5 are connected and arranged in the length direction of the belt body 2. Further, the convex section of the first snap hole 6 and the convex section of the second snap hole 8 are protruded in the length direction of and toward the belt body 2. The ratchets 10 of the first snap 7 and the ratchets 11 of the second snap 9 are parallel, that is, the angle therebetween is 0°.

Although not shown, those skilled in the art will understand that modifications can be made to the above-described embodiment. For example, the first head portion 4 and the second head portion 5 can be connected and arranged in the direction perpendicular to the length direction of the belt body 2, like the embodiment shown in FIGS. 1 and 2. Further, the convex sections of the first and second snap holes 6 and 8 are protruded toward the belt body 2. The angle between the ratchets 10 of the first snap 7 and the ratchets 11 of the second snap 9 can be 180°.

Lashing in double turns can be implemented provided that the angle between the ratchets 10 and 11 is 0° or 180°. The lashing process using such a lashing belt will be described thereinafter.

Firstly, after surrounding an object to be lashed one turn, the belt body 2 passes through the first snap hole 6. In this way, the first snap 7 in the first snap hole 6, the ratchets 10 of the first snap 7, the belt body 2 and the skew teeth 3 of the belt body 2 collectively form a first locking structure. After that, the belt body 2 surrounds the object 13 another turn in the same direction as the first turn, and then passes through the second snap hole 8. Similarly, the second snap 9 in the second snap hole 8, the ratchets 11 of the second snap 9, the belt body 2 and the skew teeth 3 of the belt body 2 collectively form a second locking structure. Thus, lashing in double turns can be implemented with the lashing belt according to this embodiment, which increases the tightening effect and saves the resources.

FIG. 6 is a schematic view illustrating a structure of a lashing belt according to still another embodiment of the present invention. The like or similar parts as the embodiment shown in FIGS. 4 and 5 will be assigned like reference numbers and repeated description thereof may be omitted.

As shown in FIG. 6, a first elastic pressing section 14 is disposed at an end of the first snap 7 and extended outside the first snap hole 6. Similarly, a second elastic pressing section 15 is disposed at an end of the second snap 9 and extended outside the second snap hole 8. By applying pressures on the first and second elastic pressing sections 14 and 15, tightness of the lashing can be adjusted, or the lashing belt can be removed from the object and be reused on another object, which further increases usage of resources. Those skilled in the art will understand that the elastic pressing sections can be applied to the embodiment shown in FIGS. 1 and 2 also.

In one embodiment of the invention, a free end 12 of the belt body 2, i.e. an end opposite to the fixed end connected with the fixed part 1, has a tapered width. In addition, besides the convex shape, the cross-sections of the first and second snap holes 6 and 8 may have a rectangular shape, an elliptical shape and so on, provided that the free end 12 of the belt body 2 can pass through the snap holes 6 and 8.

With the lashing belt according to embodiments of the present invention, lashing in both of horizontal and vertical directions or lashing in double turns in a same direction can be implemented. Thus tightening effect is increased and resources are saved.

It should be understood that the embodiments described herein should be considered in a descriptive sense only and not for purposes of limitation. Descriptions of features or aspects within each embodiment should typically be considered as available for other similar features or aspects in other embodiments.

While embodiments of the present invention have been described with reference to the figures, it will be understood by those of ordinary skill in the art that various changes in form and details may be made therein without departing from the spirit and scope of the present invention as defined by the following claims and their equivalents.

What is claimed is:

1. A lashing belt, comprising:
a belt body having a fixed end and a free end; and
a fixed part connected with the fixed end of the belt body, the fixed part comprising:
a first head portion including a first snap hole and a first snap disposed in the first snap hole; and
a second head portion including a second snap hole and a second snap disposed in the second snap hole,
wherein the belt body comprises a plurality of skew teeth on a surface of the belt body, the first and second snaps respectively comprise a plurality of ratchets, the axes of the first and second snap holes are parallel with each other.

2. The lashing belt of claim 1, wherein an angle between the ratchets of the first and second snaps is 90°.

3. The lashing belt of claim 2, wherein the first head portion and the second head portion are arranged in a length direction of the belt body.

4. The lashing belt of claim 2, wherein the first head portion and the second head portion are arranged in a direction perpendicular to a length direction of the belt body.

5. The lashing belt of claim 2, wherein cross-sections of the first and second snap holes have a convex shape.

6. The lashing belt of claim 5, wherein a convex section of the first snap hole is protruded toward the belt body.

7. The lashing belt of claim 6, wherein a convex section of the second snap hole is protruded toward the first snap hole.

8. The lashing belt of claim 1, wherein an angle between the ratchets of the first and second snaps is 0°.

9. The lashing belt of claim 8, wherein the first head portion and the second head portion are arranged in a length direction of the belt body.

10. The lashing belt of claim 8, wherein cross-sections of the first and second snap holes have a convex shape.

11. The lashing belt of claim 10, wherein a convex section of the first snap hole is protruded toward the belt body.

12. The lashing belt of claim 11, wherein a convex section of the second snap hole is protruded toward the first snap hole.

13. The lashing belt of claim 1, wherein an angle between the ratchets of the first and second snaps is 180°.

14. The lashing belt of claim 13, wherein the first head portion and the second head portion are arranged in a direction perpendicular to a length direction of the belt body.

15. The lashing belt of claim 13, wherein cross-sections of the first and second snap holes have a convex shape.

16. The lashing belt of claim 15, wherein a convex section of the first snap hole is protruded toward the belt body.

17. The lashing belt of claim 16, wherein a convex section of the second snap hole is protruded toward the first snap hole.

18. The lashing belt of claim 1, wherein cross-sections of the first and second snap holes have a rectangular shape or an elliptical shape.

19. The lashing belt of claim 1, wherein the free end of the belt body has a tapered width.

20. The lashing belt of claim 1, further comprising a first elastic pressing section disposed at an end of the first snap and extended outside the first snap hole and a second elastic pressing section disposed at an end of the second snap and extended outside the second snap hole.
